(19) United States
(12) Patent Application Publication
(10) Pub. No.: US 2023/0291954 A1
(43) Pub. Date: Sep. 14, 2023

(54) STADIUM VIDEOGRAPH

(71) Applicant: Chandrasagaran MURUGAN, JOHANNESBURG (ZA)

(72) Inventor: Chandrasagaran MURUGAN, JOHANNESBURG (ZA)

(21) Appl. No.: 17/999,439

(22) PCT Filed: May 20, 2021
(86) PCT No.: PCT/ZA2021/050034

§ 371 Date: Nov. 21, 2022

Related U.S. Application Data
(60) Provisional application No. 63/071,843, filed on Aug. 28, 2020.
(60) Provisional application No. 63/027,583, filed on May 20, 2020.

(51) Int. Cl. H04N 21/2743; H04N 21/2187; H04N 21/4788

(52) U.S. Cl. CPC H04N 21/2743; H04N 21/2187; H04N 21/4788

(57) ABSTRACT

A remote engagement system for a live event occurring at a venue includes an interactive input and output device located at the venue for providing recorded video, text, sounds, etc. to an intended recipient at the venue. A controller receives signals transmitted from a plurality of user input devices located remotely from each other and from the venue and transmits signals containing video and optionally text and/or sounds recorded by the intended recipient using the interactive input and output device to a remote user input device.

### FIELD OF THE INVENTION

Embodiments of the invention provide a remote engagement system and methods of using the same for participants at a live event to receive and specifically respond to recorded cheer images, video, text, sound, etc. sent from remote input devices.

### BACKGROUND OF THE INVENTION

Typically, one has to attend a live event in person in order to have a chance at meeting or interacting with their favorite celebrity or sports star. Remote viewers, e.g. fans watching a game from home, do not have the same ability to interact with celebrities or athletes as the live event is occurring. Thus, there is a need to provide a means for the increased engagement of remote viewers with entertainers at live events. U.S. Patent Application 2014/0317673, herein incorporated by reference, provides a remote engagement system that allows fans to convey support or discontent to the attendees at a live event, however, such a system does not provide for a two-way communication between fans and participants at the event.

### SUMMARY

The remote engagement system, according to embodiments of the invention, is a remote engagement system for a live event occurring at a venue, comprising:
at least one interactive input and output device located at the venue comprising one or more display screens or surfaces, said at least one interactive input and output device providing visual output to at least one intended recipient located at the venue; and
a controller for
(i) receiving a plurality of signals each of said plurality of signals contains at least one of recorded text and/or images for said at least one intended recipient, said signals being transmitted from a plurality of user input devices located remotely from each other and from the venue;
(ii) controlling the at least one interactive input and output device located at the venue to display at least some of the plurality of recorded text and/or images received from the plurality of user input devices, wherein the at least one intended recipient is provided as visual output the at least some of the recorded text and/or images; and
(iii) transmitting signals containing images and optionally text and/or sounds recorded by the at least one intended recipient located at the venue using the at least one interactive input and output device to at least one user input device of the plurality of user input devices.

In some embodiments, the at least one interactive input and output device is configured to allow said intended recipient at the venue to select one or more of the displayed text and/or images intended for said intended recipient and transmit said signals containing images and optionally text and/or sounds to the user input device from which the selected text and/or image originated.

In some embodiments, the venue is a stadium and optionally, the one or more display screens comprises or consists of a wall of the stadium. For example, the wall may be in a tunnel of the stadium. In some embodiments, the live event is televised or streamed over the internet.

In some embodiments, the interactive input and output device displays said recorded text and/or images transmitted from a plurality of user input devices at different locations on the one or more display screens depending on the intended recipient.

In some embodiments, at least some of the user input devices are operable only by a single user at a time of a plurality of users. The system may further comprise the plurality of user input devices located remotely from the venue for receiving a user input and in response thereto transmitting a signal in real time or near real time over a communications network.

In some embodiments, the at least one interactive input and output device further comprises one or more speakers that output a sound.

Another aspect of the invention provides methods of using a system as described herein.

Additional features and advantages of the invention will be set forth in the description below, and in part will be apparent from the description, or may be learned by practice of the invention. The advantages of the invention can be realized and attained by the exemplary structure particularly pointed out in the written description and claims hereof as well as the appended drawings.

### BRIEF DESCRIPTION OF THE DRAWINGS

FIG. 1. An illustrative embodiment of a method of using a remote engagement system.

FIG. 2. An illustrative embodiment of a remote engagement system.

FIG. 3. An illustrative embodiment of an interactive input and output device.

FIG. 4. A remote engagement system according to an additional embodiment.

FIG. 5. A remote engagement system according to an additional embodiment.

FIG. 6. An illustrative embodiment of a “Fan Room”.

FIG. 7. An illustrative embodiment of a stadium tunnel having an interactive input and output device.

### DETAILED DESCRIPTION

Embodiments of the disclosure provide a remote engagement system for a live event occurring at a venue which includes an interactive input and output device located at the venue for providing recorded text and/or images to an intended recipient at the venue. A controller receives messages, videos, and other signals transmitted from a plurality of user input devices located remotely from each other and from the venue, permits the intended recipient to review some or all of the messages, videos and other signals at a display at the venue, allows the recipient to selectively record a message, video, or other signal responsive to the message he or she received and reviewed on the display and transmit signals containing images and optionally text and/or sounds recorded by the intended recipient using the interactive input and output device to the remote user input device of the user that sent him or her the message to which he or she is responding to.

A system as described herein allows for fans watching a live event occurring at a venue, e.g. on television or over the internet, to send messages (e.g. using a mobile phone) containing cheer images, text, images/video, and/or sound to entertainers (e.g. athletes, celebrities, speakers) at the venue. Cheer images may include a representation of the fan (e.g. a picture or avatar of the fan) and their mode of cheering (e.g. flag waving) and may also include additional information such as the decibel level of the cheering and a time stamp of when the cheer occurred. The messages can be displayed on a large screen (e.g. projected on a wall of the venue) such that the intended recipient and, optionally, others within the venue may view the messages. The intended recipient, i.e. the athlete, music artist, or other entertainer can then select individual messages and send a personalized response, a “videograph”, containing text, images/video, and/or sound back to the fan at a remote location. As used herein, the terms “images” and “video” may be used interchangeably.

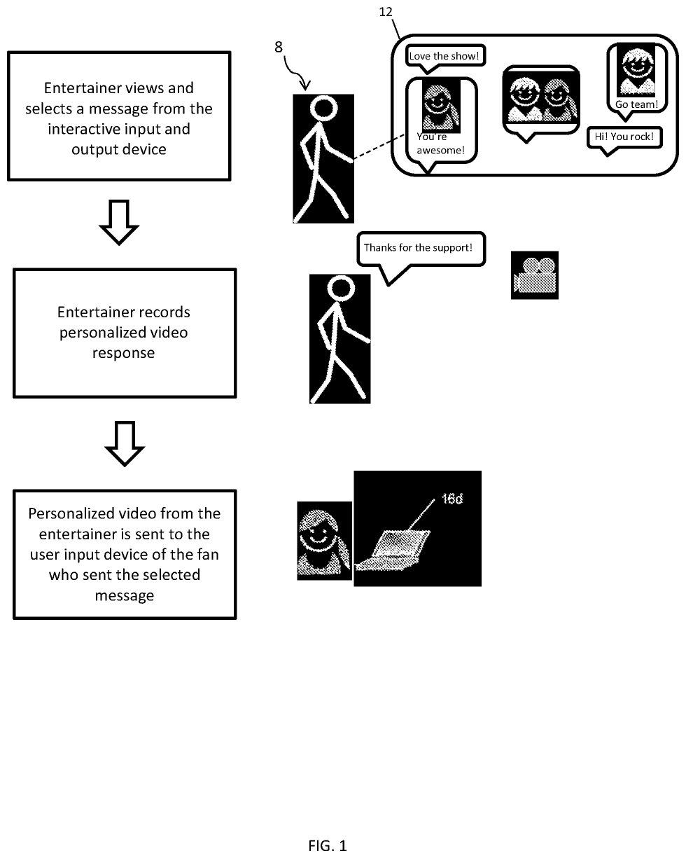

FIG. 1 provides an exemplary embodiment of a method of using a remote engagement system according the invention. Prior to the commencement of a show, during (e.g., at half time, etc.), or after a show an entertainer 8 can view an interactive input and output device 12 which displays a plurality of video and/or text messages from at least some of the fans that are located at remote locations (e.g., fans that were unable to personally attend the live event (e.g., a show, rehearsal, game, team practice, scrimmage, etc.). A live event also includes activities that occur before and after the event, e.g. the show or game, as long as the entertainer is within the venue at the time of selecting and responding to the message. The entertainer 8 can select a particular message (e.g. using hand gestures, tapping the screen, using a control device, or using a voice-activated control) from among the plurality of messages in order to provide a personalized response. Through a camera having a microphone, the entertainer 8 records the response (e.g. using hand gestures, tapping the screen, using a control device, or using a voice-activated control) and the “videograph” is then selectively or automatically sent to the user input device (e.g. a laptop computer 16c, phone, or other device) of the fan who sent the selected message.

In some embodiments, the responsive message (videograph) may be a pre-recorded response containing text, images/video, and/or sound that is selectively or automatically sent to the user input device. In some embodiments, the intended recipient may send a pre-recorded response to multiple fans at once. For example, multiple fans may send a message containing a “high five”, e.g. as an emoji/emoticon, and the intended recipient may return a “high five” to all fans sending such a message by making an appropriate selection on the interactive input and output device.

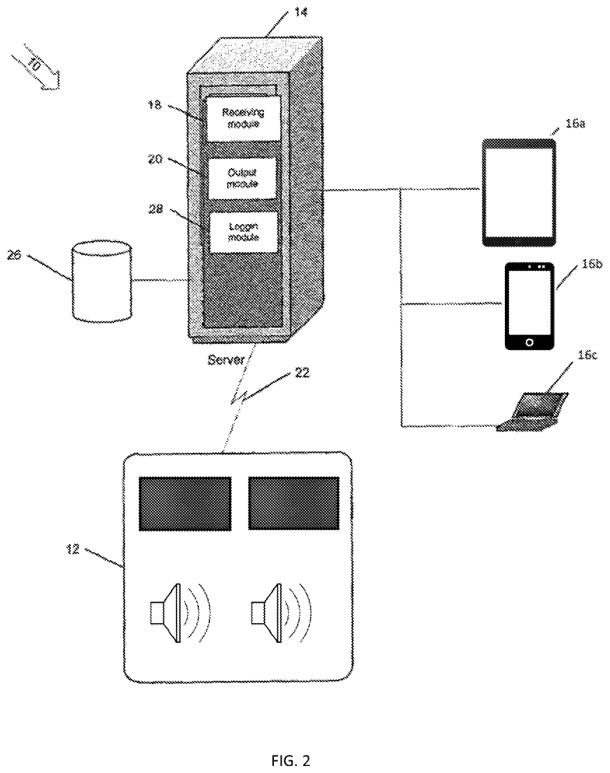

In FIG. 2, a remote engagement system 10 for a live event is illustrated. The live event could be any live event such as a sporting event, a live performance, a rally having one or more speakers, etc. The live event may occur at a stadium, concert hall, theater, television studio, or any other venue suitable for live events.

The system 10 includes at least one interactive input and output device 12 located at the live event for providing a visual and optionally an audio output to people at the live event. The at least one interactive input and output device 12 could be one or more video resources in the form of display screens and optionally one or more audio resources in the form of speakers.

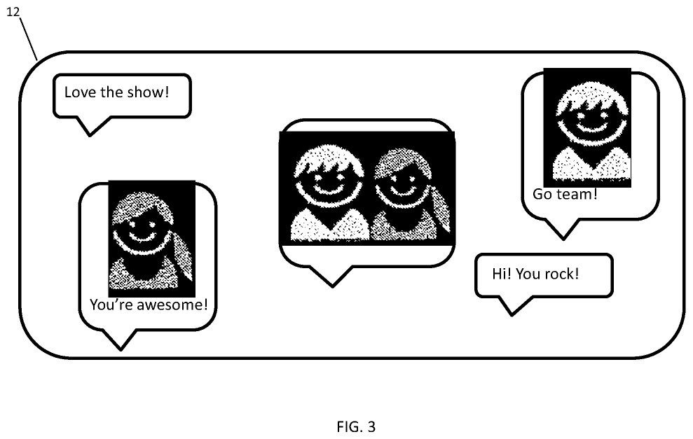

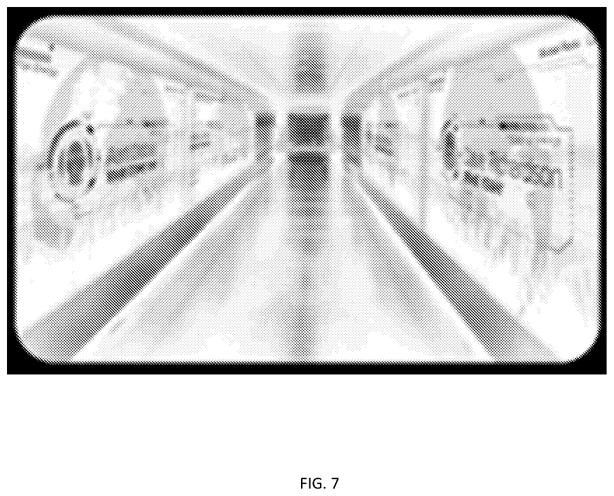

FIG. 3 shows an illustrative embodiment of the interactive input and output device 12. For example, a display screen can be mounted or projected onto a wall of a stadium, e.g. inside the tunnel that athletes pass through before taking the field (FIG. 7). The tunnel may be a permanent fixture of the stadium or a non-permanent, removable tunnel, such as an expandable tunnel. In some embodiments, there may be two interactive input and output devices, one for each team. In some embodiments, the interactive input and output devices are in one or more rooms within the stadium (i.e. a “Fan Room”), for example as part of or as an extension of a locker room.

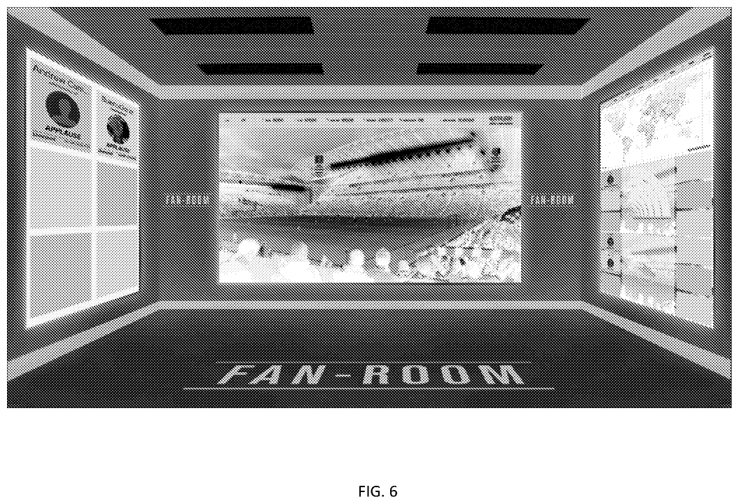

FIG. 6 shows an exemplary “Fan Room” having three display screens of an interactive input and output device mounted on separate walls. In this example, the intended recipient (e.g. the athlete) may select and respond to individual fan messages on display screen or select and respond to multiple fan messages falling within certain categories on the same or a different display screen, such as all fans sending a “high five” emoji/emoticon. The “Fan Room” may also provide a time stamp to indicate when one or more fans indicated applause—this would help differentiate, for example, a fan for one team cheering for a score from another fan of an opposing team booing for the same score. These actions may, and time stamps may be displayed with the fan's likeness on a wall, or they be presented as bubbles which float across a screen which shows the game in progress. In addition, sensors can be used to sense gestures of fans (clapping, standing, jumping, etc.) and information about these gestures may be sent to the computer system such that an indication of the gesture, and preferably the gesture with a time stamp, may be displayed at the stadium or at other locations. Furthermore, the decibel level of individual fans cheering, or the aggregate decibel level of all of the fans cheering may be displayed so that those present at the stadium or those viewing from their own homes may be apprised of how hard fans not present at the event are cheering or booing. While this has been described in the context of a “Fan Room”, it should be understood that this display might be anywhere in the stadium and function as a “vibe board” so fans can see and hear from remote fans while they are at the stadium and have a better appreciation of the more universal game vibe. In addition, this “Fan Room” might be streamed over the internet so that those watching from their portable devices such as phones, tablets, and portable computers might be able to see the input of other fans on the vibe board while a game or show progresses.

The input and output device 12 may also include one or more speakers. A plurality of messages from fans containing varying combinations of text, images, video, and sound are displayed on the screen. An athlete, or other participant in the live event, may then select one or more of the messages and send a personalized message back to the fan. Thus, the interactive input and output device 12 may also comprise a touchscreen display, keyboard, and/or remote control for selecting messages. A camera and microphone are used to record the personalized message, i.e. “videograph”. In another embodiment, the athlete or other participant uses a tablet computer or similar device to select and/or record messages.

In some embodiments, the interactive input and output device 12 displays fans' recorded text and/or images transmitted from a plurality of user input devices at different locations on the one or more display screens depending on the intended recipient. For example, each member of a sports team or music group may have a designated area on the screen of the input and output device where messages for the specific athlete or performer will be displayed.

In the case of an audio output, ambient noise sensors at the event in one embodiment are used to ensure that the audio output is matched to the ambient noise at the stadium. Thus, if the stadium crowd is quiet the audio output will be relatively lower whereas if the stadium crowd is noisy the audio output will be relatively higher.

As shown in FIG. 2, the system includes a controller in the form of server 14 that is arranged to receive signals transmitted from a plurality of user input devices 16a-16c, the signals being transmitted from a plurality of user input devices located remotely from each other and from the venue. In response thereto and in real time or near real time, the controller controls the at least one interactive input and output device 12 to display at least some of the plurality of recorded text and/or images received from the plurality of user input devices 16a-16c, wherein the at least one intended recipient is provided as audiovisual and/or textual output at least some of the recorded text and/or images.

The controller is also used to transmit signals containing images and optionally text and/or sounds recorded by the at least one intended recipient located at the venue using the at least one interactive input and output device to at least one user input device of the plurality of user input devices. That is, the athlete or entertainer can use the interactive input and output device to create and send a personalized message to one or more selected fans. For example, a striker can thank a fan named Meg for being a frequent supporter/viewer of his team's games, and then thank a fan named Whitney for cheering his game winning goal. Meg and Whitney will then be elated that their favorite player has sent them a “videograph”, i.e., a personal message from the striker meant only for them. Meg and Whitney would likely share this message with their family and friends by social media, texting or e-mail for the next few weeks. This viral messaging will likely lead to stronger support for the striker and his or her team from Meg and Whitney and friends of Meg and Whitney.

In some embodiments, at least some of the user input devices are operable only by a single user at a time of a plurality of users. The system may further comprise the plurality of user input devices located remotely from the venue for receiving a user input and in response thereto transmitting a signal in real time or near real time over a communications network. Examples of user input devices include, but are not limited to, mobile telephones 16b or tablet 16a, desktop, or laptop 16c, computers or wearable devices such as a smart watch worn on the wrist of a user or smart glasses or contacts worn over the eyes of a user. The plurality of input devices 16a-16c are located remotely from the live event. Thus, it will be typically located at a place where viewers are watching the live event remotely, for example by television or streaming over the internet.

In the example of the mobile telephone, a user wishing to send a message to a participant at the live event will dial a certain number or send an audiovisual or data message to a certain number using the mobile telephone 16b which will be transmitted over a telephone network to a receiving module 18 of the server 14. The server 14 has a database 26 associated therewith for storing data.

Alternatively, or in addition, an application could be run on the mobile telephone to provide the user with touch screen user input options or the user may use the mobile telephone to access a webpage to record a text and/or video message.

The user may use a computer as the input device. In one example, the input is transmitted over a communications network in the form of the internet to the receiving module 18.

Another example user input device is a tablet running an application to provide the user with touch screen user input options or by mean of which the user can access a webpage or application.

Alternatively, or in addition, TVs are built with options and accessories to engage with audio and video resources at events. As an example, a TV with live resource engagement options would be able to deliver the live images and/or sounds from a remote location to an event.

The server 14 includes a number of modules to implement an example embodiment. In one example embodiment, the modules described below may be implemented by a machine-readable medium embodying instructions which, when executed by a machine, cause the machine to perform any of the methods described above.

In another example embodiment, the modules may be implemented using firmware programmed specifically to execute the method described herein.

It will be appreciated that embodiments of the present invention are not limited to such architecture, and could equally well find application in a distributed, or peer-to-peer, architecture system. Thus, the modules illustrated could be located on one or more servers operated by one or more institutions.

It will also be appreciated that in any of these cases the modules form a physical apparatus with physical modules specifically for executing the steps of the method described herein.

The server 14 includes an output module 20 to control the output devices 12 to provide the visual and optionally audio output through the interactive input and output device 12. The server 14 is typically connected to the interactive input and output device 12 via a communications network 22 which may be hardwired or a wireless network. The output module 20 manages the output at the event so that the visual and optionally audio output provided is related to the signals received from the plurality of input devices 16a-c.

Thus, using a system of the invention, fans will be able to deliver their messages to entertainers at the event in real time or near real time from anywhere that has the necessary network connectivity (such as internet connectivity).

The controller in the form of server 14 will receive resource requests and manage output to resources. The controller functions include, but are not limited to, the following:
1. Video and Sound Filtering
2. Max sound volume
3. User engagement logging
   a. Points tallying for loyalty services
   b. Verification of user engagement
   c. Timeless record of engagement
4. Scheduling and blending engagement services
5. Distribution, by load etc.
6. Advanced features

A logging module 28 logs all user activities. The logs will be available to users on request to verify remote participation. Additionally, a points scheme can be derived for fan activity on the system. Points will be tallied for loyalty services and competitions.

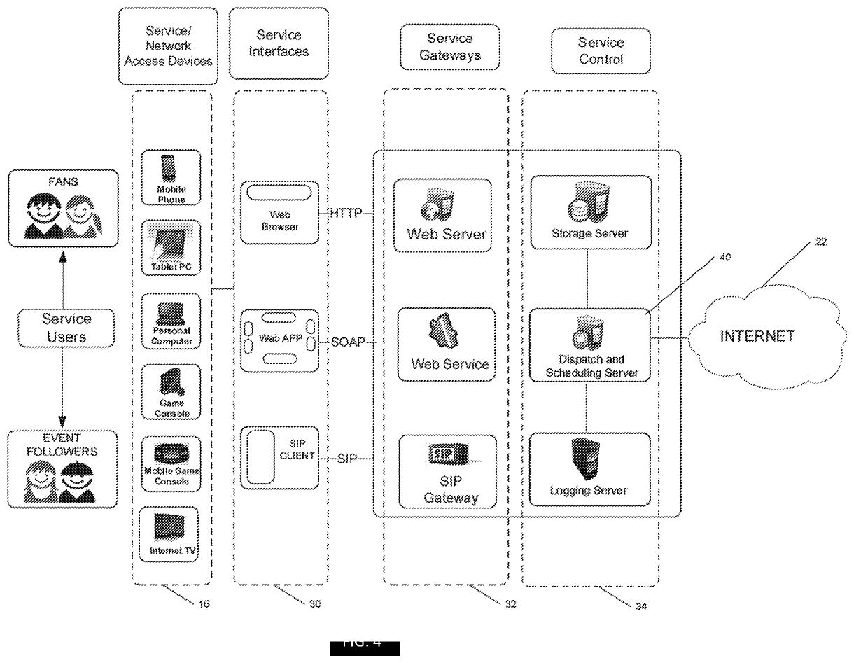

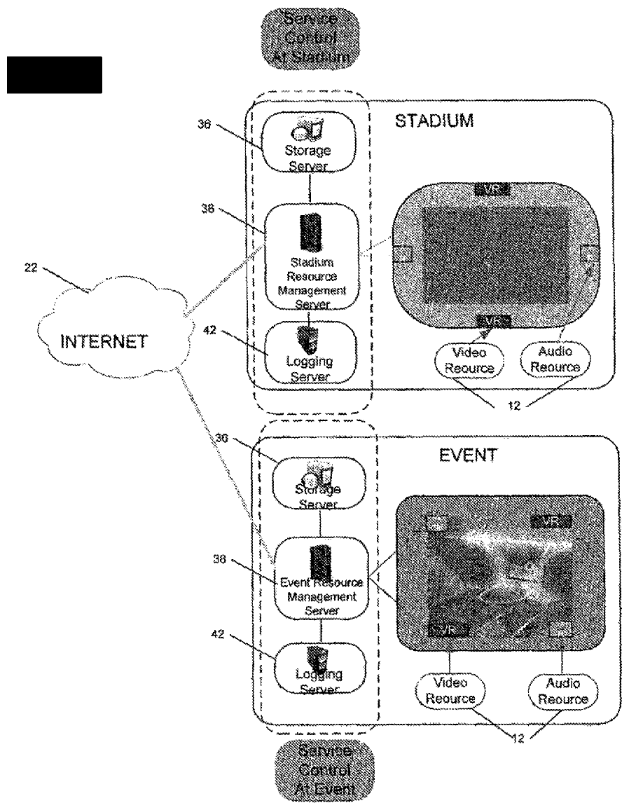

Referring to FIGS. 4 and 5, an example embodiment of the invention is described in more detail. A user accesses a service request input web page via a web browser 30 on a web server 32 using HTTP over a network such as the Internet. It will be appreciated that the network can be the Internet and/or another IP based network for example a GSM based network or other type of network that facilitates the access of resources remotely. The accessed web page has HTML input elements such as buttons. The web page is prepared in a version of HTML that can include HTML version 5 and future HTML versions.

Alternatively, input options for services are requested via a custom application that accesses a custom Web Service over a network such as the Internet. The Web Service has access to output resources at a Sports Venue or Event Location. Web Service standards and protocols are used in developing the system.

The application is typically developed in Java to facilitate easier access to input device components such a microphone. The applications can be also developed in other languages including C++. Services initiated or requested via the application are typically delivered via a Web Service. The remote access device running the application uses XML, HTTP and/or SOAP (Simple Object Access Protocol) to make requests from the application, to activate services. Other Web Service platform elements such as WSDL are also used where necessary.

The input options on the web page or application are engaged to initiate audio, video and graphics based services over a network such as the Internet.

Users may choose to include generic recorded sounds with their messages. These are pre-recorded sounds such as the sound of clapping, cheers, booing, sighs, etc. Sound files are stored in a storage service 36 at the event or stadium and is linked to an event/stadium resource management server 38. The decibel level of the recorded sound may also be measured (with louder yells of approval having higher decibel levels, etc.). The management server may also be programmed to add the detected decibel levels from different users at different times, and compute the aggregate decibel level of all of the users at any one time period or time span. This reduces network traffic and bandwidth utilization for the service. The event/stadium resource management server 38 and sound files can also be off site but must maintain network connectivity to the audio and video resources 12 over a network such as the Internet. In some embodiments, the event/stadium resource management server 38 fulfills at least part of the function of the output module 20 of FIG. 2.

When an input option is engaged by the user, a software service request instruction is prepared depending on the service type requested and sent to a dispatch and scheduling component that resides on a dispatch and scheduling server 40. In a typical deployment, the web server component and dispatch and scheduling server component will be installed on the same server. The dispatch and scheduling server can receive: a single service request instruction from a user, multiple service requests from a single user, a single service request from multiple users, or multiple service requests from multiple users.

The dispatch and scheduling server 40 aggregates requests and schedules delivery of requests to an event/stadium resource management server 38. Thus, it will be appreciated that in this embodiment the server 14 illustrated in FIG. 2 is distributed over a plurality of servers. Requests are delivered from the dispatch and scheduling server 40 to the event/stadium resource management server 38 over an IP based network. TCP, UDP and SCTP (Stream Control Transmission Protocol) are used to manage delivery of requests depending on service type. Services also make use of SIP (Session initiation Protocol) where necessary to improve effectiveness.

The event/stadium resource management server 38 receives the aggregate service requests, unpacks and interprets the requests, and passes instructions to audio, video and other resources 12 depending on the services requested.

A user's activity is logged on a logging server 42 that is linked to the event/stadium resource management server 38 for verification and additional services such as points for participation for users.

The event/stadium resource management server 38 is typically connected to the audio resource 12, video resource 12 and any other resources in one of the following ways: via an IP based network, via wireless protocol based access at the event/stadium, via cables, or audio resources can have additional components such as amplifiers and sound filters.

A live service enables users to transmit live video and/or audio remotely to an event or stadium by using the necessary networked enabled devices and software. A live service user accesses a live service application (Web App) that is installed on an Internet enabled device 16 such as a smart phone, smart watch, or tablet PC, for example. The Web App can in part be a SIP (Session Initiation Protocol) client or must be able to access a SIP client on the Internet enabled device. This is to establish connectivity to a SIP Gateway appliance over an IP network such as the Internet to be able to access and use the live sound service at the event or stadium.

In some embodiments, the live sound service operates similarly to a large-scale push to talk over IP service. The live visual and/or audio media is delivered using RTP (Real Time Protocol) and SRTP (Secure Real Time Protocol) where necessary. Other real-time data delivery protocols will be utilized when necessary to improve the effectiveness and efficiency of the system. Where necessary also, the signaling and live visual and/or audio media passes through the event/stadium resource management server 38 to access the video and/or audio resources 12 at an event or stadium.

A live service user can also activate the live service via a web page. An input control button on the web page when activated uses the camera and/or microphone of the network access device to transmit live video and sound. SIP and RTP or SRTP is typically used to establish connectivity to visual and audio resources at an event or stadium to deliver the live media in real time.

A recorded service enables a service user to record video and/or sounds such as cheers in their own voice and to store it on a storage unit either at the stadium/event or in a cloud computing infrastructure that is linked to the system. Recorded service users, record video and/or sounds in their own voices and store the files on a storage unit that is linked to the system. The recorded media is also linked to the system profile of the service user that recorded the media. Service users can manage access to the files they create.

Access to services that play that the recorded media at stadiums and events are available via a web page or custom applications developed for the various platforms such as Android, Apple IOS etc. From a web page the recorded media user selects and activates a recorded message to be played at the stadium. The request is submitted using HTTP over a network such as the Internet. The request is received and processed by a web server and passed to the dispatch and scheduling server 40 where requests are aggregated if necessary and scheduled for dispatch to the event/stadium resource management server 38.

The delivery of the resource requests, together with the delivery of the media file that contains the users recorded message, to the event/stadium resource management server is managed by the dispatch and scheduling server 40. For network efficiency and reduced bandwidth utilization for the recorded service, a caching server that caches media files to prevent unnecessary retransmissions, is linked to the event/stadium resource management server and activated when necessary.

Communication for the recorded media service between the dispatch and scheduling server and the event/stadium resource management server is established over a network that is IP based with UDP, TCP and/or SCTP managing data flow. SIP and RTP will be used when necessary to improve the effectiveness and efficiency of the recorded media service.

An event or stadium can have multiple groups of event/stadium resource management servers linked to multiple groups of resources to support more than a 100 million service users or more concurrently if necessary and improve resiliency. Similarly, multiple service gateways dispatch and scheduling servers and other system elements can also be deployed for a stadium or event to improve system resiliency to increase service and user concurrency.

Thus, it will be appreciated that remote viewers of live events will have a way of sending messages to people actually present at the live event and receiving personalized messages in return.

It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

We claim:

1. A remote engagement system for a live event occurring at a venue, comprising:
at least one interactive input and output device located at the venue comprising one or more display screens or surfaces, said at least one interactive input and output device providing visual output to at least one intended recipient located at the venue; and
a controller for
(i) receiving a plurality of signals each of said plurality of signals contains at least one of recorded video, images, or text for said at least one intended recipient, said signals being transmitted from a plurality of user input devices located remotely from each other and from the venue;
(ii) controlling the at least one interactive input and output device located at the venue to display at least some of the plurality of recorded video, images, or text received from the plurality of user input devices, wherein the at least one intended recipient is provided as visual output the at least some of the recorded video, images, or text; and
(iii) transmitting signals containing images and/or video and optionally text and/or sounds recorded by the at least one intended recipient located at the venue using the at least one interactive input and output device to at least one user input device of the plurality of user input devices.

2. The system of claim 1, wherein the at least one interactive input and output device is configured to allow said intended recipient at the venue to select one or more of the displayed video, images, or text intended for said intended recipient and transmit said signals containing images and/or video and optionally text and/or sounds to the user input device from which the selected video, images, or text originated.

3. The system of claim 1, wherein said venue is a stadium.

4. The system of claim 3, wherein the one or more display screens comprises or consists of a wall of the stadium.

5. The system of claim 4, wherein said wall is in a tunnel or room of the stadium.

6. The system of claim 1, wherein said venue is a television studio.

7. The system of claim 1, wherein said interactive input and output device displays said recorded video, images, or text transmitted from a plurality of user input devices at different locations on the one or more display screens depending on the intended recipient.

8. The system of claim 1, wherein said live event is televised or streamed over the internet.

9. The system of claim 1, wherein at least some of the user input devices are operable only by a single user at a time of a plurality of users.

10. The system of claim 1, further comprising the plurality of user input devices located remotely from the venue for receiving a user input and in response thereto transmitting a signal in real time or near real time over a communications network.

11. The system of claim 1, wherein the at least one interactive input and output device further comprises one or more speakers that output a sound.

12. A remote engagement method for a live event occurring at a venue, comprising:
(i) receiving a plurality of signals each of said plurality of signals contains at least one of recorded video, images, or text for said at least one intended recipient, said signals being transmitted from a plurality of user input devices located remotely from each other and from the venue;
(ii) controlling at least one interactive input and output device located at the venue to display at least some of the plurality of recorded video, images, or text received from the plurality of user input devices, wherein the at least one intended recipient is provided as visual output the at least some of the recorded video, images, or text; and
(iii) transmitting signals containing video and/or images and optionally text and/or sounds recorded by the at least one intended recipient located at the venue using the at least one interactive input and output device to at least one user input device of the plurality of user input devices.

13. The method of claim 12, wherein the at least one interactive input and output device is configured to allow said intended recipient at the venue to select one or more of the displayed video, images, or text intended for said intended recipient and transmit said signals containing video and/or images and optionally text and/or sounds to the user input device from which the selected video, images, or text originated.

14. The method of claim 12, wherein said venue is a stadium.

15. The method of claim 14, wherein the one or more display screens comprises or consists of a wall of the stadium.

16. The method of claim 15, wherein said wall is in a tunnel or room of the stadium.

17. The method of claim 12, wherein said venue is a television studio.

18. The method of claim 12, wherein said interactive input and output device displays said recorded video, images, or text transmitted from a plurality of user input devices at different locations on the one or more display screens depending on the intended recipient.

19. The method of claim 12, wherein said live event is televised or streamed over the internet.

20. The method of claim 12, wherein at least some of the user input devices are operable only by a single user at a time of a plurality of users.

21. The method of claim 12, wherein the at least one interactive input and output device further comprises one or more speakers that output a sound.
